(19) United States
(12) Patent Application Publication
(10) Pub. No.: US 2014/0214524 A1
(43) Pub. Date: Jul. 31, 2014

(54) RANKING OF ADVERTISEMENTS FOR POLICY COMPLIANCE REVIEW

(71) Applicant: Facebook, Inc., Menlo Park, CA (US)

(72) Inventors: Nuwan Senaratna, Sunnyvale, CA (US); Austin Byrne, Austin, TX (US); Michelle Filiba, San Francisco, CA (US); Joshua Zhi Han Lim, Mountain View, CA (US)

(73) Assignee: Facebook, Inc., Menlo Park, CA (US)

(21) Appl. No.: 13/756,525

(22) Filed: Jan. 31, 2013

(51) Int. Cl. G06Q 30/02

(52) U.S. Cl. CPC G06Q 30/0242
USPC 705/14.41

(57) ABSTRACT

An online system determines the order in which advertisements or advertisements components are reviewed for compliance with policies of the online system based on a calculated score indicating the expected revenue for presenting the advertisement or advertisement(s) including the component to online system users. The score may also reflect additional metrics, such as the time to review, the quality, and the resources for review, calculated for the advertisement or for the component. Based on the score, the advertisements or components are ranked in an order to be reviewed for compliance with policies of the online system.

### BACKGROUND

This invention relates generally to online systems, and in particular to reviewing advertisements in an online system.

Many online systems generate revenue from advertisements presented to their users. Presenting advertisements to users of an online system allows advertisers to persuade an audience to continue taking or to take action regarding to their products, services, opinions, or causes. This allows an online system to generate revenue from advertisers while allowing the advertisers to access the online system's users.

Online systems often require advertisements to adhere to certain policies before they are presented by the online system. Conventionally, online systems review advertisements for policy compliance in the order the advertisements were received from advertisers. Some online systems prioritize review of advertisements for advertisers having agreements with the online systems guaranteeing review of advertisements within a certain amount of time. However, this prioritization scheme does not account for factors such as: potential revenue lost while an advertisement is awaiting review, time-sensitivity issues requiring the expedited review of an advertisement, quality of an advertisement, or cost to review an advertisement.

### SUMMARY

An online system derives revenue by presenting advertisements to its users. Advertisements presented by the online system often must comply with one or more policies of the online system before they may be presented, so the online system reviews received advertisements for compliance with the one or more policies. Conventionally, online systems review advertisements in the order they are received from advertisers. While some online systems make agreements with certain advertisers specifying a maximum amount of time the online system may take to review advertisements from the certain advertisers, these agreements merely prioritize advertisements for policy compliance review to guarantee review within the specified maximum amount of time. However, additional factors are relevant to determining the order in which an online system reviews advertisements to maximize the online system's revenue.

To more determine the order of advertisement review for compliance with one or more policies, an online system calculates an advertisement's score for one or more factors. An advertisement's score determines the rank of the advertisement in a queue (a″review queue“) for policy compliance review. Examples of factors include the expected revenue for presenting an advertisement to online system users, the expected level of interest of the online system users in the advertisement, the amount of resources used for reviewing the advertisement, and the amount of time for the online system to review the advertisement. In one embodiment, an advertisement that has been scored and ranked in the review queue is moved to the top of the review queue or is otherwise prioritized for review if it has been in the review queue for at least a threshold amount of time.

Rather than ranking entire advertisements for policy compliance review, advertisements may be divided into components, which are each scored and ranked in the review queue accordingly. Examples of components include a title, a body, one or more images, one or more landing pages, accounts identifying advertisers, or other suitable information. The rank of an advertisement's component may be affected by the advertisements available for presentation to online system users if the component is reviewed and/or the other components of the advertisement awaiting review before presentation of the advertisement.

### BRIEF DESCRIPTION OF THE DRAWINGS

FIG. 1 is a block diagram of a system environment in which an online system operates, in accordance with an embodiment of the invention.

FIG. 2 is a block diagram of an online system, in accordance with an embodiment of the invention.

FIG. 3 is a flow chart of a method for ranking an advertisement for review, in accordance with an embodiment of the invention.

FIG. 4 is a flow chart of a method for ranking components of an advertisement for review, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

An online system derives revenue by presenting advertisements to its users and may perform various functions to present advertisements. For example, the online system may act as a publishing system by receiving advertisements from advertisers and presenting the advertisements directly to users. As another example, the online system acts as an advertising network by receiving advertisements from advertisers and providing them to other publishing websites. However, the online system may provide any functionality suitable for presenting advertisements to its users.

Often, an online system reviews advertisements for compliance with one or more policies before the advertisements may be presented to users. In some configurations, the online system divides received advertisements into components (e.g., title, content, image, landing page, etc.) and individually ranks each component for review or ranks each advertisement for review as a whole. The ranking determines the order in which the advertisements are reviewed for compliance with the one or more policies. An example of a component review process is further described in U.S. patent application Ser. No. 13/756,357, filed on Jan. 31, 2013, which is hereby incorporated by reference in its entirety.

To rank advertisements or components, the expected revenue for the advertisement or for one or more components of the advertisement is calculated. The expected value indicates the expected revenue to the online system for presenting the advertisement or for presenting one or more advertisements including the component to users. Additional metrics for advertisements or components may be computed and also used for ranking Examples of additional include: an advertiser experience metric that describes an amount of time for the online system to review advertisements or advertisement(s) including a component, a quality metric that indicates an expected level of interest of users of the online system in the advertisement or advertisement(s) including the component, and a cost to review metric that indicates an estimated amount of resources (time and human and computer reviewers) used to review an advertisement or a component.

Based on a score computed from the expected revenue and/or combination of the advertiser experience metric, the quality metric, and the cost to review metric, the advertisement or component is ranked in the review queue. Once ranked, an advertisement or component may be prioritized for review (e.g., moved to the top of the review queue or moved to a higher position in the review queue) if it has been in the review queue for at least a threshold amount of time. This prevents an advertisement or component from remaining in the review queue for a prolonged period of time.

Advertisements or components may be reviewed electronically or manually. The advertisements or components ranked in a review queue may be electronically reviewed by default, but may be manually reviewed if there is an indication that electronic review will be inadequate. For example, if an advertisement contains several images, electronic review may be unable to accurately distinguish between images in compliance with a policy and images in violation of the policy. In such cases, the online system may direct the advertisement into a queue for manual review. In one embodiment, the online system maintains separate review queues for electronic review and for manual review. In another embodiment, the online system maintains only an electronic review queue or a manual review queue.

In addition to ranking advertisements or components for policy compliance review, the computed score may help update the online system's advertisement inventory. For example, if an advertisement surpasses a threshold amount of negative feedback after presentation (e.g., users indicating that they found the advertisement offensive, misleading, etc.), the online system computes a score used to additionally review the advertisement for possible remedial action. Examples of remedial actions by the online system include removing the advertisement from its advertisement store, decreasing a bid amount for the advertisement, increasing the cost to the advertiser for presenting the advertisement, etc. This additional review may be manually performed manually if the initial review was electronically performed.

The computed score may also be used to determine advertisement placement after review. In one embodiment, advertisements having scores indicating a higher value to the online system may be placed in more prominent locations to encourage user interaction. For example, advertisements having at least a threshold score may be presented in a feed of stories presented to a user while advertisements with scores less than the threshold are presented in an advertisement-specific location.

### System Architecture

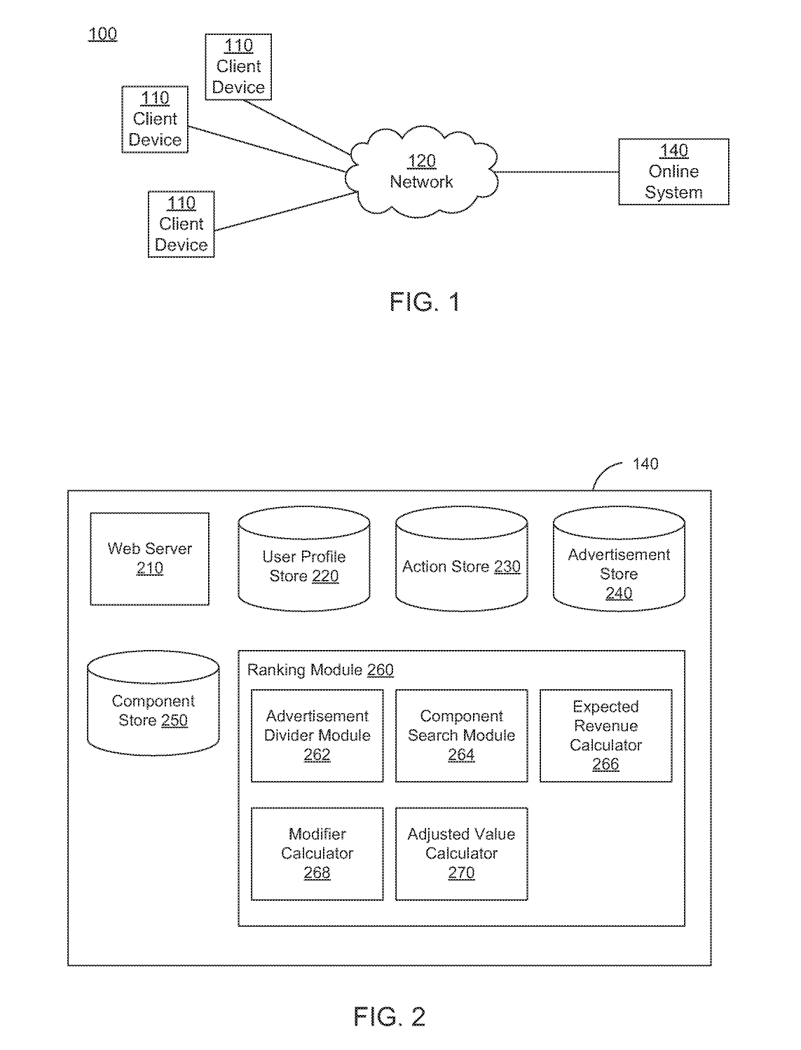

FIG. 1 is a high level block diagram illustrating a system environment 100 for an online system 140. The system environment 100 comprises one or more client devices 110, a network 120, and an online system 140, such as a social networking system. Users and advertisers connect to the online system 140 via client devices 110 through the network 120. In alternative configurations, different and/or additional components may be included in the system environment 100.

The client devices 110 comprise one or more computing devices capable of receiving user input as well as transmitting and/or receiving data via the network 120. In one embodiment, a client device 110 is a conventional computer system, such as a desktop or laptop computer. In another embodiment, a client device 110 may be a device having computer functionality, such as a personal digital assistant (PDA), a mobile telephone, a smart-phone or other similar device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. As another example, a client device 110 interacts with the online system 140 through an application programming interface (API) that runs on the native operating system of the client device 110, such as IOS® or ANDROID™.

The client devices 110 are configured to communicate via the network 120, which may comprise any combination of local area and/or wide area networks, using both wired and wireless communication systems. In one embodiment, the network 120 uses standard communications technologies and/or protocols. Thus, the network 120 may include communication channels using technologies such as Ethernet, 802.11, worldwide interoperability for microwave access (WiMAX), 3G, 4G, code division multiple access (CDMA), digital subscriber line (DSL), etc. Similarly, the networking protocols used on the network 120 may include multiprotocol label switching (MPLS), transmission control protocol/Internet protocol (TCP/IP), User Datagram Protocol (UDP), hypertext transport protocol (HTTP), simple mail transfer protocol (SMTP) and file transfer protocol (FTP). Data exchanged over the network 120 may be represented using technologies and/or formats including hypertext markup language (HTML) or extensible markup language (XML). In addition, all or some of the communication channels may be encrypted using conventional encryption technologies such as secure sockets layer (SSL), transport layer security (TLS), and Internet Protocol security (IPsec).

FIG. 2 is a block diagram of an example architecture of the online system 140. The online system 140 includes a web server 210, a user profile store 220, an action store 230, an advertisement store 240, a component store 250, and a ranking module 260. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

The web server 210 links the online system 140 to the one or more client devices 110, as well as to the one or more third party websites, via the network 120. The web server 210 serves web pages, as well as other web-related content, such as JAVA®, FLASH®, XML and so forth. The web server 210 may receive and route messages between the online system 140 and the client device 110, for example, instant messages, queued messages (e.g., email), text and short message service (SMS) messages, or messages sent using any other suitable messaging technique. A user may send a request to the web server 210 for the online system 140 to store information or to retrieve information from the online system 140. Additionally, the web server 210 may provide API functionality to send data directly to native client device operating systems, such as IOS®, ANDROID™, WEBOS® or RIM®.

Each user of the online system 140 is associated with a user account, which is typically associated with a single user profile stored in the user profile store 220. A user profile includes declarative information about the user that was explicitly shared by the user, and may also include profile information inferred by the online system 140. In one embodiment, a user profile includes multiple data fields, each data field describing one or more attributes of the corresponding user of the online system 140. Hence, user profile information stored in the user profile store 220 describes characteristics of the users of the online system 140, including biographic, demographic, and other types of descriptive information, such as work experience, educational history, gender, hobbies or preferences, location, and any other suitable information. User profile information may also include data describing one or more relationships between a user and other users. Additionally, the user profile store 220 may also store other information provided by the user, for example, images or videos. A user profile may also maintain references to actions performed by the corresponding user and stored in the action store 230.

The online system 140 receives communications about user actions internal to and/or external to the online system 140 and populates the action store 230 with information describing user actions. Examples of actions include: adding a connection to another user, sending a message to another user, uploading an image, reading a message from another user, viewing content associated with another user, attending an event posted by another user, or any other suitable actions. Users may interact with various objects maintained by the online system 140, and these interactions are stored in the action store 230. Examples of interactions with objects stored in the action store 230 include: commenting on posts, sharing links, and checking-in to physical locations via a mobile device or other client device 110. Additional examples of interactions with objects on the online system 140 included in the action store 230 include commenting on a photo album, communicating a message to a user, becoming a fan of a musician, adding an event to a calendar, joining groups, becoming a fan of a brand page, creating an event, authorizing an application, using an application, interacting with an advertisement and engaging in a transaction.

The advertisement store 240 stores information describing advertisements received by the online system 140 and a review queue describing an order for reviewing the advertisements for compliance with one or more policies. Examples of information describing advertisements include bid price (e.g., amount charged to an advertiser for presenting an advertisement), budget, targeting criteria defining a target group of users of the online system 140 eligible to receive an advertisement, and historical revenue associated with an advertiser. This information may be manually provided through an interface provided by the online system 140, may be received via information from an advertiser, or may be received in any other suitable manner. In some embodiments, the advertisement store 240 stores advertisements satisfying one or more policies of the online system 140 and does not store advertisements that do not satisfy one or more policies of the online system 140. Additionally, the advertisement store 240 may remove advertisements after a threshold length of time. Other embodiments may maintain advertisements in the advertisement store 240 even if the advertisements do not satisfy one or more policies of the online system 140 or after the threshold length of time.

The component store 250 stores information describing components of the advertisements in the advertisement store 240, including components ranked for review and components not ranked for review. Information associating the components with their corresponding advertisements is also maintained by the component store 250.. The component store 250 also stores information indicating whether a component satisfies one or more policies of the online system 140. In some embodiments, the component store 250 stores components in their entirety. Alternatively, the component store 250 stores a representation of the components such as a hash or a signature describing a component.

The ranking module 260 ranks advertisements, or components, for review to determine compliance with one or more policies of the online system 140. In the embodiment shown by FIG. 2, the ranking module 260 includes an advertisement divider module 262, a component search module 264, an expected revenue calculator 266, a modifier calculator 268, and an adjusted value calculator 270. However, in other embodiments, the ranking module 260 may include different and/or additional components. Additionally, some embodiments of the ranking module 260 may include fewer components than those shown by FIG. 2.

The advertisement divider module 262 partitions an advertisement into one or more components. For example, the advertisement divider module 262 partitions an advertisement into one or more of: a title, a body, an image, a landing page, and an account. The title provides a brief description of the advertisement. The body, or text, of an advertisement provides details about a product, service, or other content associated with the advertisement. The image is graphical data displayed by the advertisement. A landing page, or destination, is a web page, application, web site, or other network destination to which a user is directed when accessing the advertisement. An account identifies an advertiser associated with the advertisement. In other embodiments, advertisements may be partitioned into different and/or additional components.

When evaluating a component of an advertisement for compliance with one or more policies of the online system 140, the component search module 264 determines whether the component store 250 includes data indicating whether a component matching, or similar to, the component being evaluated satisfies one or more policies of the online system 140. If a match is found, the component search module 264 retrieves the data associated with the matching or similar component and uses that data to indicate whether the component being evaluated satisfies one or more policies of the online system 140. If the component search module 264 determines from information in the component store 250 that a component matching, or similar to, the component being evaluated has been ranked by the ranking module 260 but has not yet been reviewed for policy compliance, the selected component is not ranked for review; once the matching or similar component is reviewed, the component search module 264 retrieves the data associated with the matching or similar component and uses that data to indicate whether the component being evaluated satisfies one or more policies of the online system 140. If the component search module 264 determines that the component being evaluated matches, or is similar to, a component that has previously been reviewed for policy compliance and that one or more policies have changed since the review, the selected component is ranked by the ranking module 260 for additional review by the online system 140. Determining similarity between components is further disclosed in U.S. patent application Ser. No. 13/756,357, filed on Jan. 31, 2013, which is hereby incorporated by reference in its entirety.

The expected revenue calculator 266 calculates the expected revenue for presenting an advertisement or for presenting advertisements containing a component to online system users. The expected revenue calculator 266 may compute the expected revenue based on one or more of: a bid price, a budget, and/or targeting criteria associated with an advertisement from the advertisement store 240 or associated with a component of one or more advertisements from the component store 250. For example, the expected revenue for an advertisement that has a low bid price, a small budget, and a narrow audience is lower than an advertisement with a higher bid price, a larger budget, and a broader audience. Additionally, historical revenue information associated with an advertiser may also be used to compute expected revenue. For example, the expected revenue calculator 266 may account for the amount of revenue previously generated by the online system 140 from prior advertisements from an advertiser. Additionally, the expected revenue calculator 266 may account for the likelihood of user interaction with an advertisement; for example, the expected revenue may account for the probability of a user accessing an advertisement.

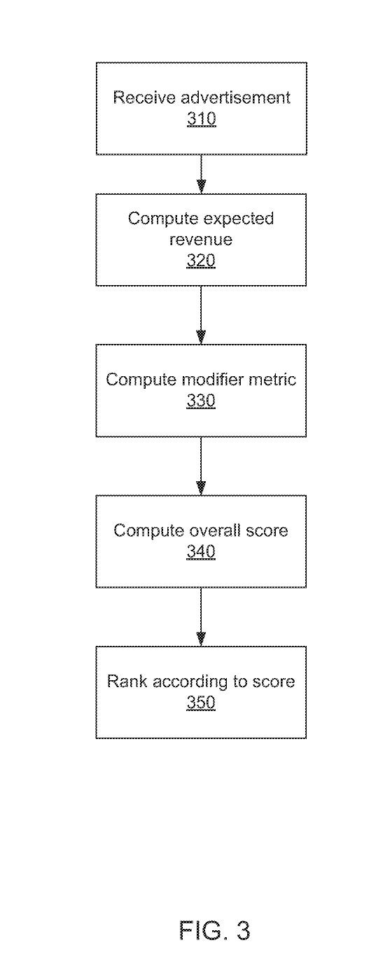

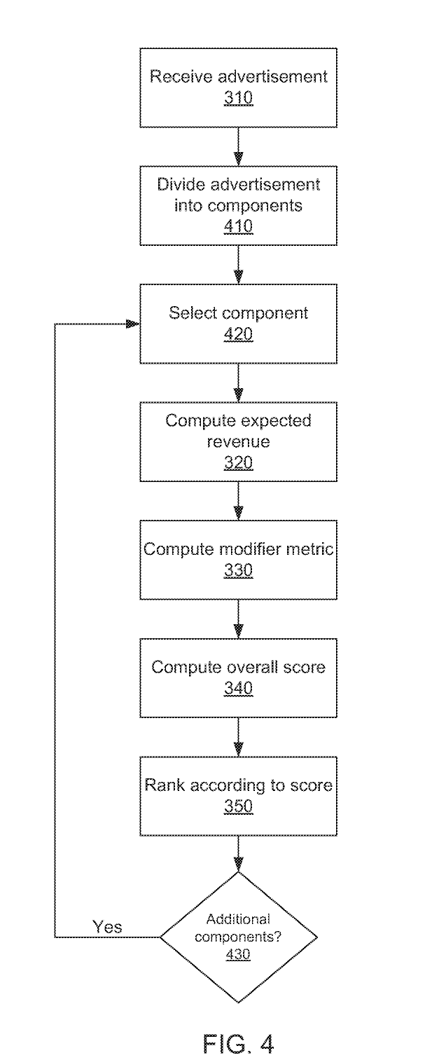

The modifier calculator 268 calculates one or more additional metrics for an advertisement or for a component. For example, the modifier calculator 268 calculates one or more of: an advertiser experience metric, a quality metric, and a cost to review metric. The advertiser experience metric, quality metric, and cost to review metric are further described below and in conjunction with FIGS. 3 and 4.

The advertiser experience metric is based on an estimated time to review an advertisement or a component. In one embodiment, a higher value of the advertiser experience metric corresponds to a shorter turnaround time, which corresponds to a better experience for the advertiser. Information associated with an advertiser, such as volume of ads placed (e.g., a higher value associated with an advertiser placing 1000 ads than an advertiser placing 10 ads) may be used to calculate the advertiser experience metric. Additionally, a partner value may be assigned to an advertiser by the online system 140 reflecting information associated with the advertiser (e.g., a higher value associated with an advertiser with an advertising contract with the online system 140 than an advertiser without an advertising contract) may be used to determine the advertiser experience metric. In one embodiment, the advertiser experience metric accounts for time-sensitive information in an advertisement that would prioritize an advertisement for publication. For example, the advertiser experience metric may be higher for advertisements describing sponsored stories or flash sales as such advertisements are less likely to be relevant to users after a specified length of time. In another embodiment, the online system 140 may implement one or more rules that prioritize advertisements or components for review after a threshold amount of time has elapsed since the advertisement or component was ranked in the review queue. For example, an advertisement that has been queued for review may be moved to the top of the review queue or to a higher position in the review queue if it has been in the queue for more than one hour.

The quality metric indicates the quality of an advertisement. In one embodiment, a higher value corresponds to a higher quality advertisement or to a component of one or more higher-quality advertisements. For an advertisement, the quality metric may be based on user feedback for similar advertisements that have previously been published. The degree of similarity between advertisements for a previously published advertisement to be taken into account may depend on a number of common components between the advertisements being compared. For example, a previously published advertisement is taken into account if it has at least a threshold number of components in common with an advertisement being reviewed. For a component, the quality metric may be based on user feedback for advertisements that have previously been published and that contain the same or a similar component, as identified by the component search module 264. The user feedback may include both non-explicit feedback (e.g., click-through rate) and explicit feedback (e.g., users directly indicating that they found an advertisement offensive).

The modifier calculator 268 may associate different weights with feedback from various targeting criteria associated with an advertisement when determining the quality metric. The targeting criteria identify a group of online system users eligible to be presented an advertisement, allowing the online system 140 to account for the advertisement's audience. For example, the modifier calculator 268 may assign a lower weight to advertisements or components of advertisements with broad targeting criteria and a higher weight to advertisements or components of advertisements with narrow targeting criteria in order to expand the advertisement inventory for more narrowly defined audiences. Additionally, the modifier calculator 268 may associate different weights with feedback for advertisements received from different users. For example, if the online system 140 determines that a user providing feedback is a suspected imposter of another user or is not a member of a demographic group relevant to the advertisement, modifier calculator 268 may assign a lower weight to the user's feedback when determining the quality metric.

The cost to review metric describes the resources used by the online system 140 to review an advertisement or a component. For example, the cost to review metric describes the electronic and/or human resources used to review an advertisement or a component.. In one embodiment, a higher value of the cost to review metric corresponds to a lower amount of resources for review. Human resources are more expensive than electronic resources and may be necessary to review advertisements or components that are not easily electronically reviewed (e.g., pictures), so in some embodiments the cost to review metric differently weights human resources and electronic resources.

The adjusted value calculator 270 combines the expected revenue, the advertiser experience metric, the quality metric, and/or the cost to review metric to generate an overall score for an advertisement or a component. In various embodiments, the above described metrics may be used alone or in any suitable combination to determine the score. The adjusted value calculator 270 may associate different weights with different components when determining the score for an advertisement or a component. Based on the score, the ranking module 260 ranks the advertisements or components for policy compliance review. In one embodiment, a higher score corresponds to a higher position in the review queue.

### Advertisement Ranking

FIG. 3 illustrates one embodiment of a method for ranking an advertisement for review. When the online system receives 310 an advertisement from an advertiser, the expected revenue calculator 266 calculates 320 the expected revenue to the online system 140 for presenting the advertisement to users of the online system 140. In one embodiment, the modifier calculator 268 also calculates 330 a modifier metric based on the advertiser experience metric, the quality metric, and/or the cost to review metric. For example, the modifier metric is a weighted combination of one or more of the advertiser experience metric, the quality metric, and the cost to review metric calculated 330. The adjusted value calculator 270 computes 340 an overall score by combining the expected revenue and modifier metric. Alternatively, the adjusted value calculator 270 uses expected revenue alone to calculate the overall score. Based on the overall score, the ranking module 260 ranks 350 the advertisement for review. For example, the advertisement is provided with a position in a review queue based on its score.

### Component Ranking

FIG. 4 illustrates one embodiment of a method for ranking a component for review. When the online system receives 310 an advertisement from an advertiser, the advertisement divider module 262 divides 410 the advertisement into one or more components, as described above in conjunction with FIG. 2. The component search module 264 identifies one or more of the components for ranking For example, the component search module 264 applies one or more rules to select components for ranking or may select components for ranking based on characteristics of the advertisement. A component from the components selected for ranking is selected 420, and the expected revenue calculator 266 calculates 320 the expected revenue for presenting advertisements containing the selected component to online system users. In one embodiment, the modifier calculator 268 calculates 330 the modifier metric as described above in conjunction with FIG. 3. Using the expected revenue and the modifier metric, the adjusted value calculator 270 computes 340 an overall score for the selected component. Alternatively, the adjusted value calculator 270 uses only the expected revenue to calculate the overall score of the component. Based on the overall score, the ranking module 260 ranks 350 the component for review. If the ranking module 260 determines 430 there are additional components of the advertisement selected for ranking, an additional component is selected and ranked, as described above, until all the components of the advertisement being reviewed are ranked in the review queue.

In one embodiment, the overall score of a component is affected by the advertisements available to be presented to users of the online system 140 once the component is reviewed. For example, the online system 140 may determine which un-reviewed advertisements contain a component being ranked for review. Based on this determination, the online system may compute the overall score of the component by adding or by otherwise combining the scores for advertisements containing the component, increasing the priority of the component in the review queue.

In another embodiment, the online system discounts or otherwise adjusts the overall score for a component based on a number of components to be reviewed for a complete advertisement to be reviewed. For example, the online system 140 may retrieve scores for every advertisement including a component, divide the score for each advertisement by the number of additional components of the advertisement that have not yet been reviewed, and then combine these discounted scores to generate the overall score for the component. Hence, rather than combining scores of advertisements including a component, the online system 140 may discount the advertisement scores based on the completeness with which the advertisements have been reviewed.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure. Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described. Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
receiving, at an online system, information about one or more advertisements from one or more advertisers;
computing a score for each of the one or more advertisements, the score based at least in part on an expected revenue for presenting the advertisement to users of the online system and one or more metrics selected from a group consisting of: a quality metric, an advertiser experience metric, a cost to review metric, and any combination thereof;
ordering the one or more advertisements to be reviewed into a review queue based at least in part on the computed scores; and
reviewing the one or more advertisements in an order based at least in part on the review queue to determine whether an advertisement being reviewed violates one or more policies of the online system.

2. The method of claim 1, wherein the expected revenue for presenting an advertisement is determined based on one or more of a group consisting of: an amount charged to an advertiser for presenting the advertisement, a budget for presenting the advertisement, targeting criteria defining a target group of users of the online system for receiving the advertisement, historical revenue information associated with the advertiser, and any combination thereof.

3. The method of claim 1, wherein the quality metric for an advertisement indicates an expected level of interest of the users of the online system in the advertisement.

4. The method of claim 1, wherein the quality metric for an advertisement is based at least in part on explicit user feedback received in connection with the advertisement.

5. The method of claim 1, wherein the quality metric for an advertisement is determined by:
associating different weights with different targeting criteria defining a target group of users of the online system for receiving the advertisement; and
determining the quality metric based on the different weights associated with the different targeting criteria.

6. The method of claim 1, wherein the cost to review metric for an advertisement indicates an estimated amount of resources needed to determine whether the advertisement violates the one or more policies of the online system.

7. The method of claim 1, wherein the advertiser experience metric for an advertisement indicates an amount of time to review the advertisement to determine whether the advertisement violates one or more policies of the online system.

8. The method of claim 1, wherein the advertiser experience metric for an advertisement is based at least in part on a partner value assigned to an advertiser by the online system.

9. The method of claim 1, wherein the advertiser experience metric for an advertisement is based at least in part on a measure of time sensitivity associated with the advertisement.

10. The method of claim 1, further comprising:
responsive to determining that one of the one or more advertisements has been queued for review for more than a predetermined time, increasing a priority of the advertisement in the review queue.

11. A method comprising:
receiving, at an online system, information about one or more advertisements from one or more advertisers;
computing a score for each of the one or more advertisements, the score based at least in part on an expected revenue for presenting the advertisement to users of the online system; and
ordering the one or more advertisements to be reviewed into a review queue based at least in part on the computed scores.

12. The method of claim 11, further comprising reviewing the one or more advertisements in an order based at least in part on the review queue to determine whether an advertisement being reviewed violates one or more policies of the online system.

13. The method of claim 11, wherein the expected revenue for presenting an advertisement is determined based on one or more of a group consisting of: an amount charged to an advertiser for presenting the advertisement, a budget for presenting the advertisement, targeting criteria defining a target group of users of the online system for receiving the advertisement, historical revenue information associated with the advertiser, and any combination thereof.

14. The method of claim 11, wherein the computed score for an advertisement is further based on a quality metric indicating an expected level of interest of the users of the online system in the advertisement.

15. The method of claim 11, wherein the computed score for an advertisement is further based on a cost to review metric indicating an estimated amount of resources needed to determine whether the advertisement violates one or more policies of the online system.

16. The method of claim 11, wherein the computed score for an advertisement is further based on an advertiser experience metric indicating an amount of time to review the advertisement to determine whether the advertisement violates one or more policies of the online system.

17. The method of claim 16, wherein the advertiser experience metric for an advertisement is based at least in part on one or more of: a partner value assigned to an advertiser by the online system and a measure of time sensitivity associated with the advertisement.

18. The method of claim 11, further comprising:
responsive to determining that one of the one or more advertisements has been queued for review for more than a predetermined time, increasing a priority of the advertisement in the review queue.

19. The method of claim 11, further comprising:
receiving, at an online system, information about one or more advertisements from one or more advertisers;
dividing each of the one or more advertisements into a plurality of components;
determining, for each component of the plurality of components, whether the component is to be reviewed based on whether the component has previously been reviewed;
computing a score for each of the components to be reviewed, the score based at least in part on an expected revenue for presenting one or more advertisements containing the components to users of the online system and one or more metrics selected from a group consisting of: a quality metric, an advertiser experience metric, a cost to review metric, and any combination thereof;
ordering the components to be reviewed into a review queue based at least in part on the computed scores; and
reviewing the components to be reviewed in an order based at least in part on the review queue to determine whether an advertisement including a component being reviewed would violate at least one policy of the online system.

20. The method of claim 19, wherein the expected revenue for a component is determined based on one or more of a group consisting of: an amount charged to an advertiser for presenting advertisements containing the component, a budget for presenting advertisements containing the component, targeting criteria defining a target group of users of the online system for receiving advertisements containing the component, historical revenue information associated with the advertiser, and any combination thereof.

21. The method of claim 19, wherein the quality metric for a component indicates an expected level of interest of the users of the online system in advertisements containing the component.

22. The method of claim 19, wherein the cost to review metric for a component indicates an estimated amount of resources needed to determine whether the component violates the one or more policies of the online system.

23. The method of claim 19, wherein the advertiser experience metric for a component indicates an amount of time to review one or more advertisements including the component to determine whether an advertisement including the component violates at least on policy of the online system.

24. The method of claim 19, wherein the advertiser experience metric for a component is based at least in part on one or more of a partner value assigned to an advertiser by the online system and a measure of time sensitivity associated with advertisements containing the component.

25. The method of claim 19, further comprising:
responsive to determining that a components to be reviewed has been queued for review for more than a predetermined time, increasing a priority of the component in the review queue.
